(19) United States
(12) Patent Application Publication
(10) Pub. No.: US 2008/0037065 A1
(43) Pub. Date: Feb. 14, 2008

(54) Computer readable medium storing printing program, electronic device, electronic device control method, and computer data signal

(75) Inventor: Tomoya Kawata, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/591,603

(22) Filed: Nov. 2, 2006

(30) Foreign Application Priority Data
Aug. 9, 2006 (JP) 2006-217367

(51) Int. Cl. G06K 15/00

(52) U.S. Cl. 358/1.16

(57) ABSTRACT

A computer readable medium storing a printing program causing a computer to execute a process includes searching a keyword from text data and generating a signal for holding printing of the text data when the keyword has been found.

### BACKGROUND

1. Technical Field

The present invention relates to technique for confidential printing in which printing is held until operation for permitting printing is separately executed in confidential printing as well as a computer readable medium storing a printing program, an electronic device, and an electronic device control method, particularly to technique for determining confidentiality based upon printed contents and automatically converting the current mode to a confidential print mode.

2. Related Art

A function is known which adds a password to a printing job and disenabling printing unless the password is input to a printer when the printing job is transmitted from a terminal device (for example, a personal computer) to the printer so as to cause the printer to print predetermined contents. This function is called a confidential printing function and is utilized for printing a confidential document. The leakage of confidentiality by careless printing can be prevented by utilizing the confidential printing function

### SUMMARY

According to an aspect of the invention, a computer readable medium storing a printing program causing a computer to execute a process includes searching a keyword from text data and generating a signal for holding printing of the text data when the keyword has been found.

### BRIEF DESCRIPTION OF THE DRAWINGS

Exemplary embodiments of the present invention will be described in detail based on the following figures, wherein:

FIGS. 1A and 1B are conceptual drawings showing the outline of printing operation in an exemplary embodiment;

FIG. 2 is a block diagram showing the outline of a terminal device and a printer in the exemplary embodiment;

FIGS. 3A and 3B show one example of screens displayed on a display of the terminal device;

FIG. 4 is a flowchart showing one example of the printing operation in the exemplary embodiment;

FIG. 5 shows one example of a screen displayed on the display of the terminal device;

FIG. 6 is a conceptual drawing showing the outline of printing operation in an exemplary embodiment;

FIG. 7 is a block diagram showing the outline of a printer in the exemplary embodiment; and

FIG. 8 is a block diagram showing the outline of a terminal device in an exemplary embodiment.

### DETAILED DESCRIPTION

### First Embodiment

### (Outline of Exemplary Embodiment)

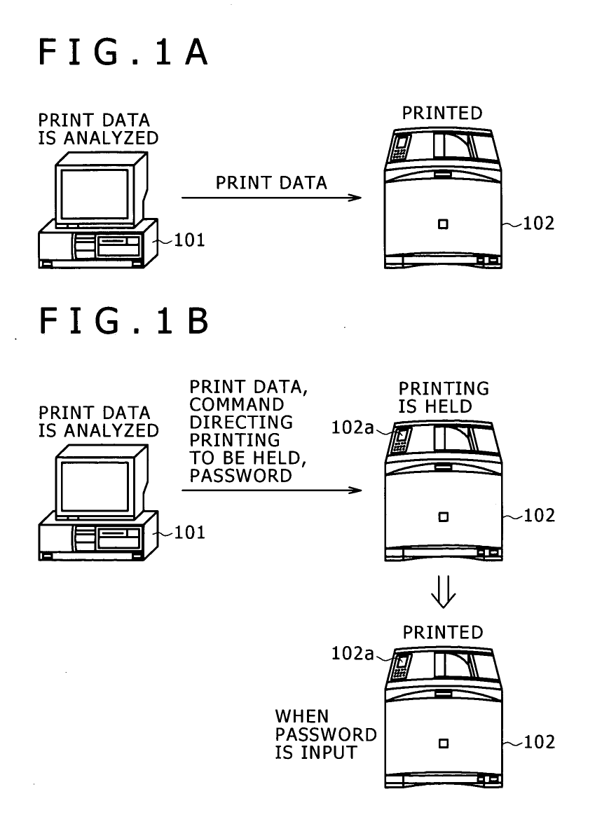

FIGS. 1A and 1B are conceptual drawings for explaining the outline of the operation in this exemplary embodiment. FIG. 1A shows a case of normal printing and FIG. 1B shows a case of confidential printing. When the execution of printing is instructed by operating a terminal device 101, print data is transmitted from the terminal device 101 to a printer 102. At this time, the print data transmitted to the printer 102 is analyzed in the terminal device 101 beforehand. In the analysis, it is checked whether a predetermined keyword exists in text data in the print data or not. The print data means electronic data including the contents of printing, a printing condition and control information in printing. Generally, for print data transmitted from the terminal device 101 to the printer 102, print data converted to a plotting command of a type in which the printer 102 can interpret and plot is utilized. However, the data format of print data is not particularly limited as long as a printer can interpret the data format and can execute the printing.

Unless the predetermined keyword is retrieved, print data is transmitted from the terminal device 101 to the printer 102 as shown in FIG. 1A and normal printing is executed. This case is the same as a case that normal printing is executed. When the predetermined keyword is retrieved from print data, the terminal device 101 transmits data acquired by adding a command to instruct the hold of printing and a password to print data to the printer 102 as shown in FIG. 1B. The printer 102 that receives the data recognizes the command to instruct the hold of printing and temporarily holds operation for printing the received print data. The print data is held in the printer 102 until the hold is released. When a user inputs a predetermined password via a password input unit 102a (for example, a ten-key input unit) arranged in the printer 102 in this state in which the printing is held, it is determined whether or not the predetermined password matches a password transmitted from the terminal device 101, and when both passwords are matched, the printing is executed.

According to this mechanism, when a predetermined keyword exists in print data, the mode is turned a confidential print mode and the printer 102 is turned a state in which printing is held. When a password is input to the printer 102, it is determined whether the password is true or not and when the password is true, the state of the hold is released and printing is executed. As a format of a document which is an object of printing has no relation to confidential printing, the invention may be applied to various formats of documents.

### (Configuration of Exemplary Embodiment)

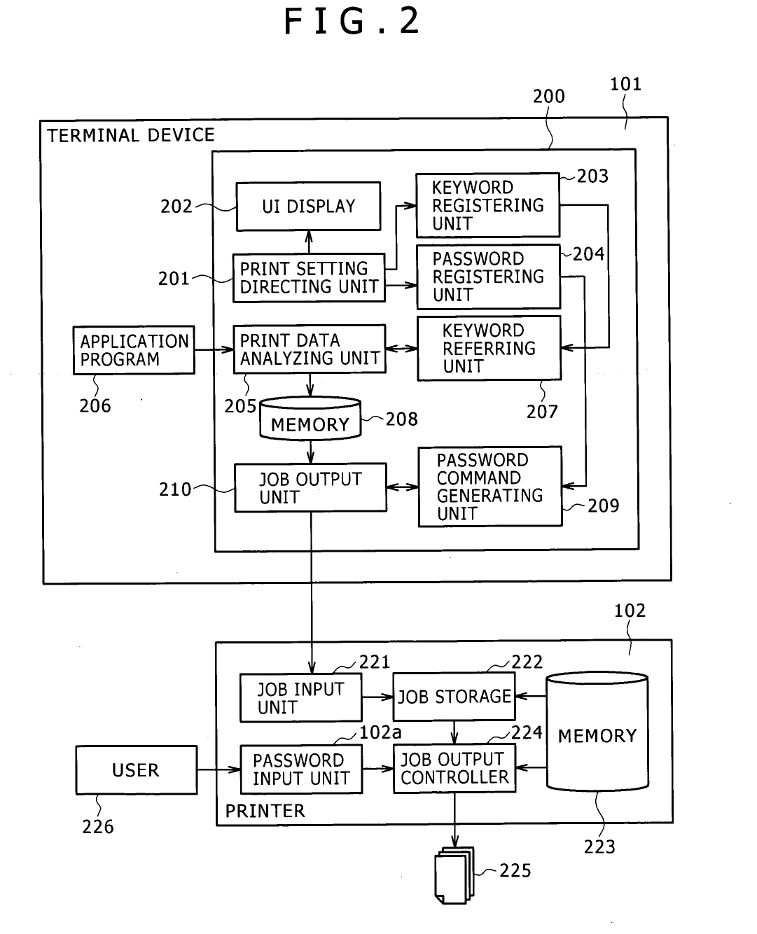

An example of the concrete configuration in this exemplary embodiment will be described in detail below. FIG. 2 is a block diagram showing the outline of the terminal device 101 and the printer 102. In this example, the terminal device 101 instructs the printer 102 to print and the printer 102 executes printing. For the terminal device 101, a personal computer in which a printer drive program for executing the following functions is installed can be utilized. Naturally, a dedicated machine provided with the following functions may also be prepared. When a personal computer is utilized for the terminal device 101, a CPU, a ROM, a RAM, an interface and a display such as a liquid crystal display with which the personal computer is normally provided are suitably utilized and combined, and operation in a functional unit shown in FIG. 2 is realized.

First, the terminal device 101 will be described. In this example, a print driver 200 is activated in the terminal device 101 by the installed printer drive program. The print driver 200 is provided with the following functional units. First, a print setting directing unit 201 is provided with a function for setting a keyword and a password. The keyword means a word which functions as a key when it is determined whether the mode is to be turned to a confidential print mode or not and which is retrieved from a document as an object of printing. For the keyword, a numeral, a predetermined expression, a document and others can also be set; however, in this exemplary embodiment, a case that a word is set as a keyword will be described. The password means a character string, a series or the combination of them utilized when a state in which printing is held in the confidential print mode is released.

A user interface (UI) display 202 is a display for displaying necessary information for a user when the user a keyword and a password are set. The set keyword (for example, a word such as “confidential” and “company president”) is stored in a keyword registering unit 203. The set password is recorded in a password registering unit 204.

A print data analyzing unit 205 retrieves a predetermined keyword from print data prepared by an application program 206. Concretely, the print data analyzing unit 205 analyzes print data including text data and image data respectively to be printed sent from the application program 206 and searches a keyword stored in the keyword registering unit 203 from the print data. The application program 206 means application software for composing or managing a document such as document composition software, document management software and spreadsheet software respectively available on the market.

A keyword referring unit 207 reads the corresponding keyword from the keyword registering unit 203 when the print data analyzing unit 205 retrieves the keyword and provides the referred keyword to the print data analyzing unit 205. A memory 208 temporarily stores and buffers the analyzed print data.

A password command generating unit 209 generates a password command when the print data analyzing unit 205 retrieves the keyword stored in the keyword registering unit 203. The password command means a command including a password recorded in the password registering unit 204 for directing the hold of printing. A job output unit 210 converts print data stored in the memory 208 to a plotting command of a type that the printer 102 can interpret and plot the print data and outputs the plotting command and a job control command designating various set conditions for the printer 102 to the printer 102 as a job. At this time, when a password command is generated, it is added to the job control command.

Next, the printer 102 will be described. A job input unit 221 receives the job sent from the terminal device 101 and sends it to a job storage 222. The job storage 222 analyzes the job control command included in the job sent from the terminal device, stores the job in a memory 223 when the password command is included in the job control command, and keeps holding printing.

When no password command is included in the job control command, the plotting command and the job control command are sent from the job storage 222 to a job output controller 224. In this case, the plotting command is executed in the job output controller 224 according to various printing conditions specified in the job control command and printing is executed. As described above, a printed matter 225 is output.

The printer 102 is provided with the password input unit 102a having a ten-key input unit and a display. When a user 226 operates the password input unit 102a of the printer 102 in the above-mentioned state in which printing is held and inputs a predetermined password, the predetermined password is sent to the job output controller 224. The job output controller 224 reads a password included in the password command of the corresponding job stored in the memory 223 and compares it with the password input via the password input unit 102a. When both passwords are matched and it is determined that the input password is true, the held printing job stored in the memory 223 is read by the job output controller 224, the plotting command is executed according to various printing conditions specified in the job control command included in the corresponding job, and printing is executed. As described above, the printed matter 225 is printed in the confidential print mode.

### (Initialization)

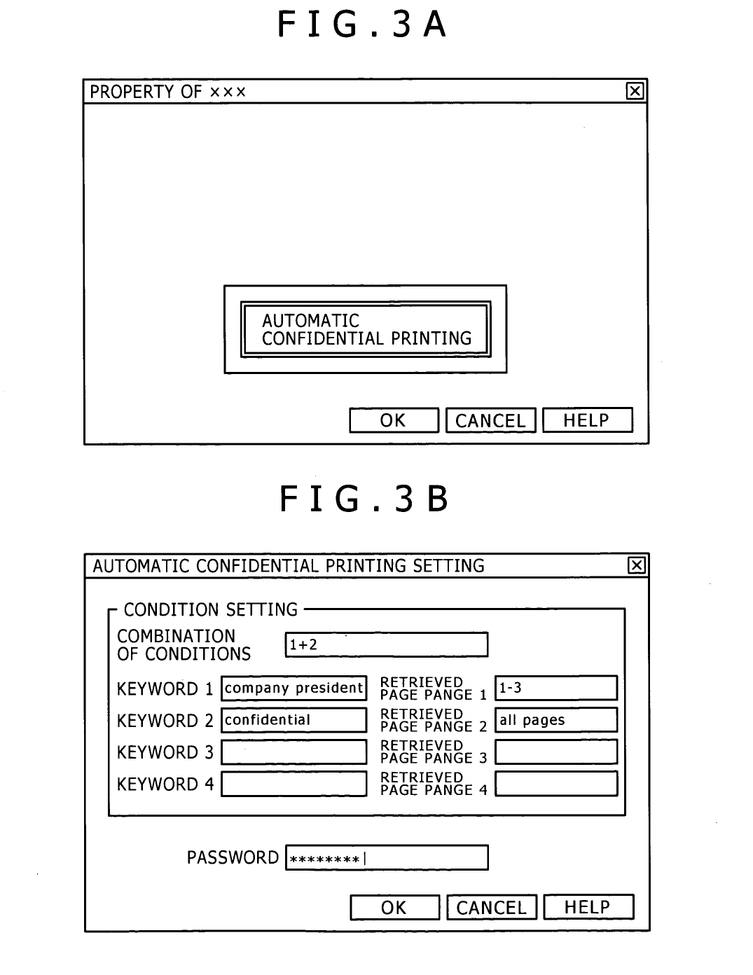

Initialization is made before printing using the configurations shown in FIGS. 1A, 1B and 2 is executed. In the initialization, the keyword and the password are registered. FIGS. 3A and 3B show an example of an initialization screen. For example, when the terminal device 101 is operated and calls the initialization screen of the print driver, a screen shown in FIG. 3A is displayed on the UI display 202. If the user utilizes a function for judging whether a confidential printing function is to be executed or not depending upon the result of analyzing whether a specific keyword is included in print data or not as described in this example, the user should click a part in which “automatic confidential printing” is displayed and further, should click “OK”. Then, the screen is switched to a screen shown in FIG. 3B. The user should set a condition for confidential printing using the screen shown in FIG. 3B. In this case, one or plural keywords, a condition of the combination and a range of retrieved pages are set. The set condition is stored in the keyword registering unit 203 shown in FIG. 2.

### (Operation in Printing)

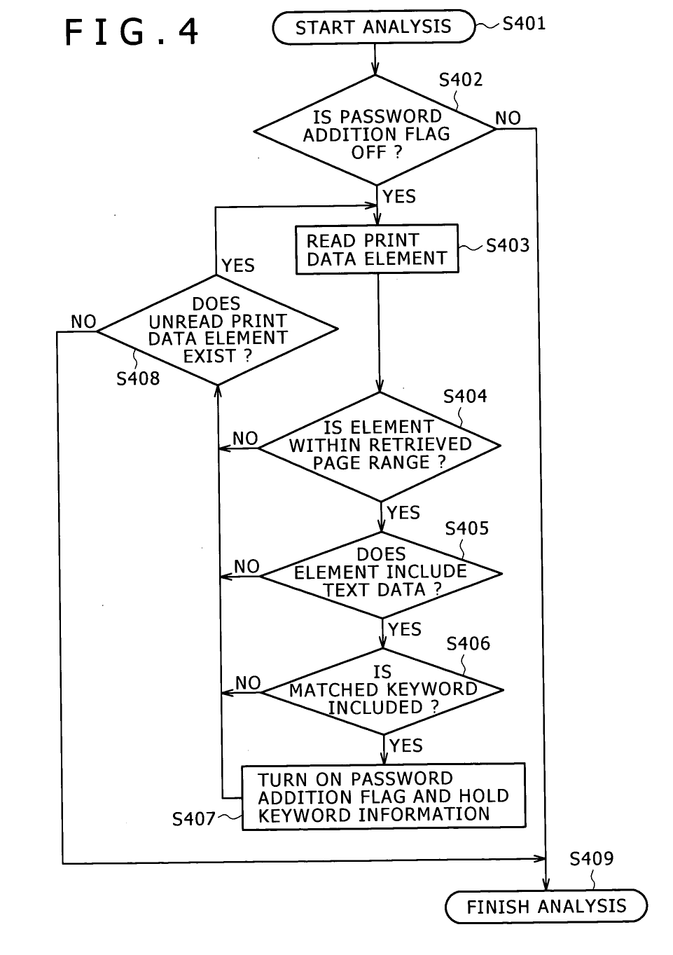

A case that the user operates the terminal device 101 to print a predetermined document will be described below. In this case, when the user performs operation for printing using the terminal device 101, the following process is executed based upon the printer drive program in the print data analyzing unit 205 in the terminal device 101. FIG. 4 is a flowchart showing one example of a procedure for the process executed at this time.

When the terminal device 101 is operated to print the predetermined document in the configurations shown in FIGS. 1A, 1B and 2, print data is sent from the application program 206 to the print data analyzing unit 205 in the print driver 200. The print data analyzing unit 205 starts analysis when the unit receives the print data (a step S401) and determines whether a password addition flag managed by the printer drive program is off or not (a step S402).

The password addition flag is a flag for telling whether the printer 102 should execute confidential printing or not. When the password addition flag is on, the printer 102 holds printing and when no password is input, printing is not executed. In the meantime, when the password addition flag is off, the printer 102 executes normal printing. When the execution of an “automatic confidential printing” function based upon the retrieval of a keyword according to the invention is set, the password addition flag is set off on the side of the printer drive program as initialization. Hereby, if a confidential printing condition is met in the following procedure, processing when the password addition flag is on is executed (the conversion to the confidential print mode is directed) and if not, processing when the password addition flag is off is executed (the execution of normal printing is directed).

As described above, as the password addition flag is set off when the execution of the “automatic confidential printing” function is set, the determination in the step S402 is “YES” and the process proceeds to a step S403. When “always confidential printing” is set, the password addition flag is on, the determination in the step S402 is “NO”, and the analysis is finished (a step S409).

In the step S403, work for reading one of print data elements (document elements) such as a one-line unit of character string data and a unit of image data respectively configuring print data received from the application program 206 is performed. The read document element is temporarily stored in a memory (for example, RAM with which the terminal device 101 is provided). The setting of a print data element is arbitrary, however, for an example, a paragraph unit, a unit of the predetermined number of words and a print page unit can be given.

Next, the process proceeds to a step S404 and it is determined whether or not the print data element read in the step S403 is in a range of pages to be retrieved which are set (input) on the screen shown in FIG. 3B. When the print data element is in the range of the pages, the process proceeds to a step S405 and if not, the process proceeds to a step S408.

In the step S405, it is determined whether or not the print data element read in the step S404 includes text data. When the print data element includes text data, the process proceeds to a step S406 and if not, the process proceeds to the step S408.

In the step S408, it is determined whether an unread print data element exists or not, when an unread print data element exists, the process proceeds to the step S403, one of the elements is read, if not, the process proceeds to the step S409, and the analyzing process is finished. Normally, print data is delimited into a print data element such as a one-line unit, is sequentially read from the first print data element in the step S403, and processing following the step S403 is executed. When analysis on all print data elements of the print data is finished, the determination in the step S408 is “NO” and the analysis is finished (the step S409).

In the step S406, it is determined whether or not a character string matched with each keyword set (input) on the screen shown in FIG. 3B exists in the text data in the print data element read in the step S403. When the character string matched with the keyword is found, the process proceeds to a step S407 and if not, the process proceeds to the step S408.

In the step S407, the password addition flag managed by the printer drive program is turned on and information related to the keyword judged to be matched in the step S406 is stored. The information related to the keyword includes a character string of the keyword, a page on which the keyword emerges and a frequency of the emergence of the keyword. The process proceeds to the step S408.

As described above, the print data is sequentially analyzed for every print data element and it is determined whether or not a set word exists in text data printed in a state in which a predetermined condition is met. When the determination is “YES”, the password addition flag for directing the conversion to the confidential print mode is turned on and if not, the password addition flag is not turned on.

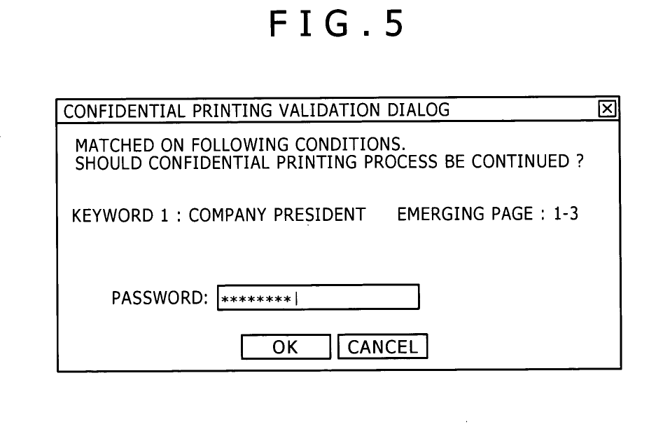

When the analysis shown in FIG. 4 is finished, the pop-up display shown in FIG. 5 of a message for informing the conversion to an automatic confidential print mode is made on the UI display 202 of the terminal device 101 if the password addition flag is on. At this time, the keyword information held in the step S407 is displayed. The user checks the pop-up display, inputs a password input when the printer 102 is instructed to output to the terminal device 101 if confidential printing is to be executed, and clicks “OK”. As a result, the print data is temporarily stored in the memory 208 together with the job control command and is sent to the job output unit 210. The job output unit 210 converts the print data to a plotting command and further, generates the job control command to which a password command is added. A job configured by the plotting command and the job control command is output from the job output unit 210 to the job input unit 221 of the printer 102. When the user clicks “cancel” on the screen shown in FIG. 5, the printing process itself is canceled.

When the password addition flag is off as a result of the analysis shown in FIG. 4, the print data is sent to the job output unit 210 after it is temporarily stored in the memory 208. At this time, the job output unit 210 adds no password command to the job control command and a job configured by the plotting command and the job control command is output from the job output unit 210 to the job input unit 221 of the printer 102.

The job received by the job input unit 221 is sent to the job storage 222. When the password command is included in the job, the job is sent from the job storage 222 to the memory 223 and is temporarily stored in the memory. That is, the job is judged to be an object of confidential printing and until the user 226 operates the password input unit 102a and inputs a predetermined password, the printing is held.

When the user 226 operates the password input unit 102a and inputs the predetermined password, it is determined in the job output controller 224 whether the password is true or not. That is, at this time, the job output controller 224 retrieves the password command included in the job stored in the memory 223 and further, acquires the password included in the password command. The job output controller compares the password input by the user 226 with the password acquired from the job in the memory 223. At this time, when both are matched, the job is transferred from the memory 223 to the job output controller 224 and printing is executed. When the two are not matched, no printing is executed and an error message is displayed on the display arranged in the password input unit 102a.

When no password command is included in the job, the job is sent from the job storage 222 to the job output controller 224. The job output controller 224 that receives the job executes printing and a printed matter 225 is output. That is, when no password command is included in the job, normal printing is executed.

As described above, the necessity of confidential printing is determined based upon the word in the printed document and if necessary, the current mode is automatically converted to the confidential print mode. In the confidential print mode, when no password is directly input to the printer 102, no printing is executed. When a document that meets no condition of confidential printing is printed, normal printing is executed. In the case of confidential printing, the terminal device can also be operated as in normal printing operation.

In this exemplary embodiment, the function of the print driver 200 shown in FIG. 2 may also be provided to a print server. In this case, a password command is added to a job by the print server in confidential printing and the job is sent to the printer. At this time, the printer performs the similar operation to the operation described in the first exemplary embodiment.

### Second Embodiment

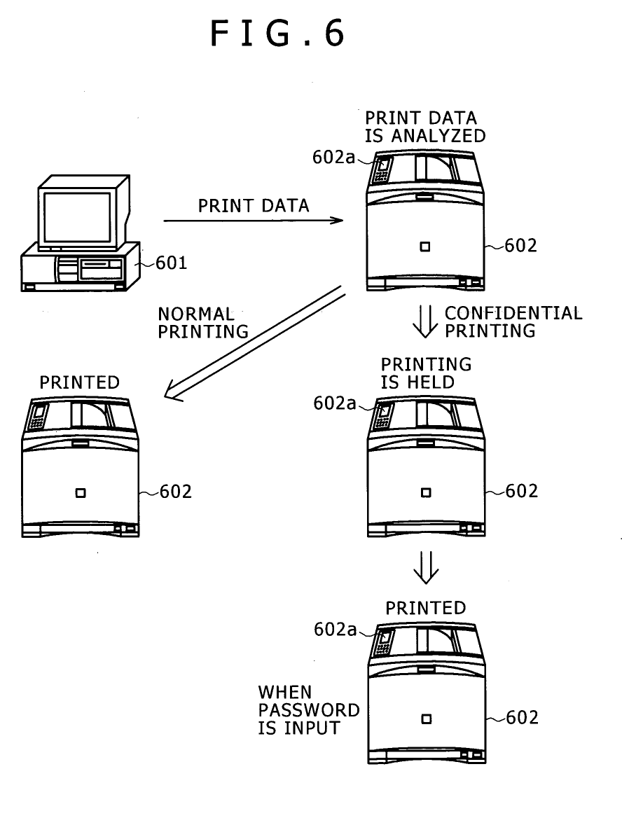

A printer may also be configured to determine whether confidential printing should be executed or not. FIG. 6 is a conceptual drawing for explaining the outline of operation in this exemplary embodiment. In this case, when a terminal device 601 is operated to instruct printing, print data is transmitted from the terminal device 601 to a printer 602. The printer 602 analyzes the print data, determines that the printing is an object of confidential printing when the print data includes a set keyword, and holds the printing. In the meantime, when no set keyword is included in the print data, normal printing is executed. When a user inputs a password via a password input unit 602a while the printing is held, the hold is released and the printing is executed.

This mechanism works better when one printer is shared among plural terminal devices. For example, a case will be described that the mechanism for the terminal device shown in FIG. 1 to analyze is applied to a network on which one printer is shared among plural terminal devices. In this case, to change a condition of confidential printing, each terminal device is operated and setting is required to be made on a setting screen shown in FIG. 3B. This work is troublesome when many terminal devices share one printer. In the meantime, as operations for setting have only to be applied to the printer 602 in the mechanism that the printer 602 shown in FIG. 6 analyzes, a change of the condition is not troublesome even if plural terminal devices 601 are connected to the printer 602. This exemplary embodiment is applicable to LAN environment in an office and others in which one printer is often shared among plural terminal devices.

### (Details of Exemplary Embodiment)

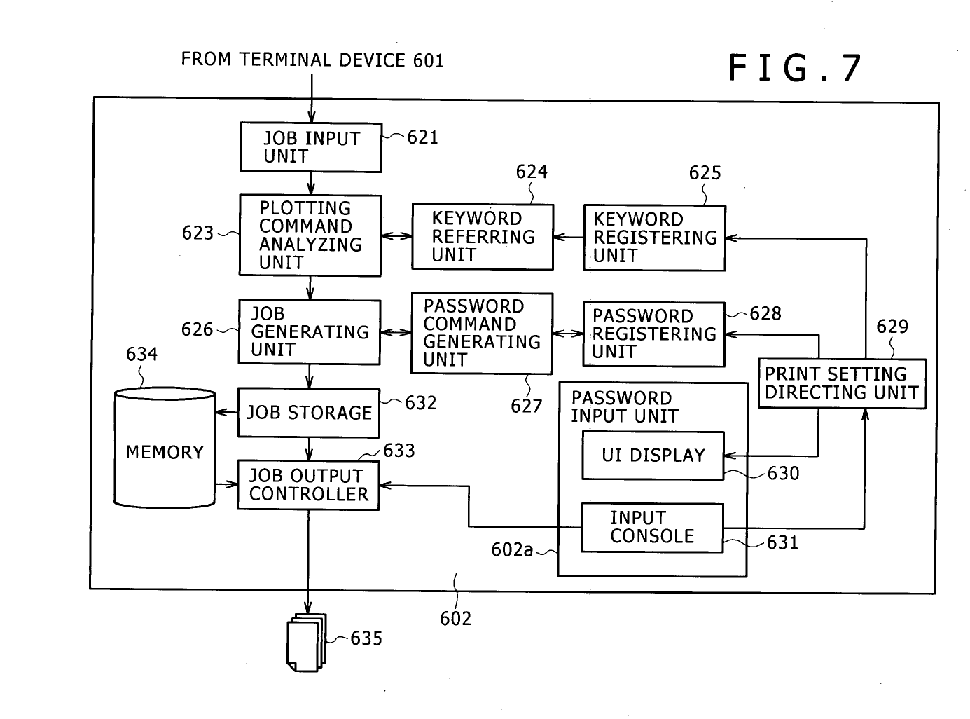

One example of the printer 602 shown in FIG. 6 will be described below. FIG. 7 is a block diagram showing the schematic configuration of the printer 602 shown in FIG. 6. A job input unit 621 shown in FIG. 7 accepts a job from a terminal device such as a personal computer. In this job, a plotting command and a job control command are included. A plotting command analyzing unit 623 is provided with the basically same function as the print data analyzing unit 205 shown in FIG. 2. The plotting command analyzing unit 623 is different from the print data analyzing unit 205 in that data to be analyzed is the plotting command transmitted from the terminal device 601. A keyword referring unit 624 is provided with the same function as the keyword referring unit 207 shown in FIG. 2. A keyword registering unit 625 is provided with the same function as the keyword registering unit 203 shown in FIG. 2. A job generating unit 626 adds a password command to the job control command in data output from the plotting command analyzing unit 623 and sends it to a job storage 632. A password command generating unit 627 is provided with the same function as the password command generating unit 209 shown in FIG. 2. A password registering unit 628 is provided with the same function as the password registering unit 204 shown in FIG. 2. A print setting directing unit 629 is provided with the same function as the print setting directing unit 201 shown in FIG. 2. The password input unit 602a is provided with a UI display 630 which is a liquid crystal display and an input console 631 having a ten-key input keyboard. The job storage 632 is provided with the same function as the job storage 222 shown in FIG. 2. A job output controller 633 is provided with the same function as that of the job output controller 224 shown in FIG. 2. A memory 634 is provided with the same function as the memory 223 shown in FIG. 2. The terminal device 601 is a personal computer in which a normal printer drive program is installed. In this example, the terminal device 601 converts print data from an application program to the plotting command and outputs it from a job output unit 210 to the printer 602 together with the job control command as a job.

### (Initialization)

In this exemplary embodiment, initialization is made by directly operating the printer 602. The initialization is made by operating the input console 631 of the password input unit 602a. A method of operation is the same as that in the first exemplary embodiment. An interface may also be devised so that the initialization can be made on the side of the terminal device. In this case, the terminal device 601 shown in FIG. 6 and the print setting directing unit 629 shown in FIG. 7 are connected via a network not shown and setting using the terminal device 601 is made.

### (Operation in Printing)

When the printing of a predetermined document is instructed by operating the terminal device 601 shown in FIG. 6, a plotting command and a job control command as a job are transmitted from the terminal device 601 to the printer 602. The printer 602 receives the job in the job input unit 621 shown in FIG. 7 and sends it to the plotting command analyzing unit 623. The plotting command analyzing unit 623 executes similar processing to the procedure shown in FIG. 4 and analyzes the plotting command. At this time, the contents of printing are recognized based upon the plotting command, and the step S403 and the following steps are executed based upon the contents. In the analysis, a preset keyword is read from the keyword registering unit 625 by the keyword referring unit 624. When the predetermined keyword exists in a state in which the keyword meets a predetermined condition, the password command generating unit 627 generates the password command and the job generating unit 626 adds it to the job control command in the job. The job is sent to the job storage 632. When no predetermined keyword exists in the state in which the predetermined keyword meets the predetermined condition, the password command generating unit 627 generates no password command and the job output from the plotting command analyzing unit 623 is sent to the job storage 632 as it is.

When no password command is added to the job, the job is sent from the job storage 632 to the job output controller 633, the printing is executed, and a printed matter 635 is output. That is, normal printing is executed. When the password command is added to the job, the job is temporarily stored in the memory 634 and the printing is held. Though it is not shown, a signal for informing of transition to a state in which the printing is held (that is, a confidential print mode) may be transmitted to the terminal device 601 and the pop-up display shown in FIG. 5 may be made on a display of the terminal device 601;

When the input console 631 of the password input unit 602a is operated and a password is input in the state in which the printing is held, the password is sent to the job output controller 633. The job output controller 633 compares the input password with a password included in the job stored in the memory 634 and determines whether both are matched or not. When both are matched, the plotting command and the job control command of the corresponding job are read from the memory 634 to the job output controller 633, these commands are executed, and a printed matter 635 is output.

In this exemplary embodiment, the example that the printer analyzes is described, however, the similar function may also be provided to a print server. In this case, print data is transmitted from the terminal device to the print server, the print server analyzes, when it is determined that confidential printing is required, the print data is temporarily stored in the print server, and the printing is held. When a password is input to the printer, it is transmitted to the print server, when the collating is right, print data is transmitted from the print server to the printer, and the held printing is executed.

### Third Embodiment

For an exemplary embodiment having the similar superiority to the second exemplary embodiment, an exemplary embodiment may be taken up that a program for analyzing print data is transmitted from a printer to a terminal device for every printing operation and the terminal device analyzes. In this case, the terminal device makes the similar analysis to that in the first exemplary embodiment and a job based upon the result of the analysis is transmitted to the printer. In the case of a confidential print mode, the hold of printing is released when a password is input to the printer. According to this exemplary embodiment, since set conditions are stored in the printer, conditions for analysis may be collectively changed on the side of the printer.

For another example of this exemplary embodiment, it may be arranged such that a program for analyzing print data is stored in a print server, a program for analyzing a plotting command is transmitted from the print server to a terminal device for every printing operation, and the terminal device also analyzes the plotting command. In this case, the terminal device makes the similar analysis to that in the first exemplary embodiment and a job based upon the result of the analysis is transmitted to the print server. In this case, in a confidential print mode, the print data is temporarily stored in the print server. When a password is input to a printer, it is transmitted to the print server and the print server determines whether the password is true or not. When the input password is true, the print data stored in the print server is transmitted to the printer and the printing is executed. A password may also be input to the print server in any method in place of the printer.

### Fourth Embodiment

In the first to third exemplary embodiments, a password is input to the terminal device and the hold of printing in confidential printing may also be released. For example, a communication section that transmits the password from the terminal device 101 to the job output controller 224 in the configuration shown in FIG. 2 is provided to the configuration. In this configuration, when a password is input to the terminal device 101 while the printing is judged to be confidential printing and the printing is held, the password is transmitted to the job output controller 224, the hold of the printing is released, and the printing is executed.

### Fifth Embodiment

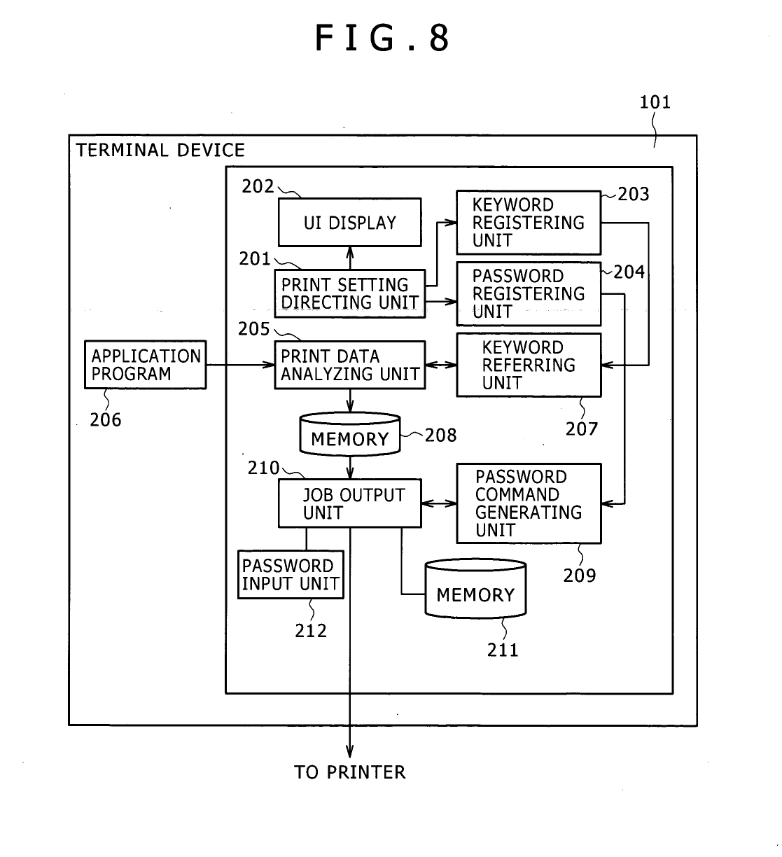

For a transformed example of the configuration shown in FIG. 2, a terminal device analyzes and when the printing is judged to be confidential printing, the terminal device may also store print data. FIG. 8 is a block diagram showing the schematic configuration of the terminal device in this exemplary embodiment. In this case, a memory 211 and a password input unit 212 are prepared in addition to the configuration shown in FIG. 2. For the memory 211, a RAM area in the terminal device 101 may be utilized and for example, the same memory area as the memory 208 is utilized. The password input unit 212 is configured by a keyboard input device provided to the terminal device 101 and its interface. The other parts are the same as those in the configuration shown in FIG. 2.

In this example, the job output unit 210 temporarily stores a job to which a password command is added in the memory 211 without transmitting the job to a printer. In confidential printing, when a password is input to the password input unit 212, the job output unit 210 determines whether the password is true or not. That is, the job output unit 210 compares a password added to the password command with the input password and determines whether both are matched or not. When both are matched, the job stored in the memory 211 is transmitted to the printer and the printing is executed (that is, the hold of the printing is released). When the passwords are not matched, a state in which the job is stored in the memory 211 is kept (that is, the hold of the printing is not released). In this example, a password may also be input to the printer. In this case, a device for transmitting the password input to the printer to the terminal device 101 has only to be prepared.

### Sixth Embodiment

In the first exemplary embodiment, in the pop-up display shown in FIG. 5 for informing a user of transition to the confidential print mode, a onetime password may also be displayed. The onetime password means a password that can be utilized only once. For the onetime password, a random sequence of numbers generated using a function for random number generation and others may be given. In this case, the user memorizes the onetime password seeing the pop-up display shown in FIG. 5, then goes to the printer and inputs the onetime password to the printer. Hereby, a state in which printing is held is released and the printing is executed.

### Seventh Embodiment

For example, in the configurations shown in FIGS. 1A, 1B and 2, identification data may also be electronically input in place of the input of a password to the password input unit 102a. For example, an IC card or a storage medium in which identification data is stored is prepared and an interface for inputting the data via the IC card or the storage medium is arranged in the printer 102. For example, configuration is adopted that electronic data is read when identification data is stored in the IC card and the IC card is brought close to the password input unit 102. In this case, when the IC card is brought close to an IC card reading unit in the printer in a state in which printing is held in a confidential print mode, the identification data is read in the printer and when the collating is right, the state in which printing is held is released. For example, confidential printing having higher security is enabled by providing the function of the IC card to an ID card of an employee of a company.

### Eighth Embodiment

To effectively fulfill a function for preventing a printed matter from being seen by a third party, a user may go on the side of a printer and the printing may be executed at that stage. For a method of realizing this mechanism, the method of directly inputting a password to the password input unit 102a of the printer 102 is adopted in the first exemplary embodiment. For another exemplary embodiment of this mechanism, a mechanism for utilizing a portable information processing terminal (for example, a mobile telephone) for a password input section may be given.

For example, a communication interface for enabling connecting the password input unit 102a of the printer 102 to the Internet is arranged in the configuration shown in FIG. 2. In addition, a mobile telephone provided with a function for connecting to the Internet is prepared. When the hold of printing is released, a password is input to the mobile telephone. The password is transmitted to the printer 102 via the Internet and the similar process to that described in the first exemplary embodiment is executed. That is, when the input password is true, the hold of the printing is released and a printing job stored in the memory 223 is executed.

Besides, for example, a communication interface not shown for connecting the terminal device 101 to the Internet is arranged in the configuration shown in FIG. 8. In addition, a mobile telephone provided with a function for connecting to the Internet is prepared. When the hold of printing is released, a password is input to the mobile telephone. The password is transmitted to the terminal device 101 via the Internet and is further sent to the job output unit 210. The similar process to that described in the fifth exemplary embodiment is executed. That is, when the input password is true, the hold of the printing is released and a printing job stored in the memory 211 is executed.

### Ninth Embodiment

An object of analysis for searching a keyword is not limited to actually printed contents. For example, some application programs are provided with a function for adding a document name, a creator's name, a responsible department name, a comment and others in addition to printed contents to print data and allowing them to be seen on a screen of a terminal device. Of course, the unprinted contents can also be an object of analysis in addition to printed contents needless to say. In this case, data related to the unprinted contents is added to a printing job and the printing job has only to be analyzed. When this function is used, an expression which can be verified on a display and which is actually unprinted on a printed matter such as “For exclusive use of confidential printing” can be utilized as a keyword.

### Tenth Embodiment

Biometric person authentication technology may also be utilized for a process for releasing the hold of printing. That is, biometric person authentication information may also be utilized for identification data for releasing the hold of printing. For the biometric person authentication information, irises, a fingerprint, a vein pattern, a voiceprint and others can be utilized. In this case, confidential printing in which held printing is disenabled when the biometric authentication information of a registered specific person cannot be recognized can be realized.

The invention can be utilized for a terminal device such as a personal computer connected to a printer, the printer, a print server, a network including the printer and the control of them.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a printing program causing a computer to execute a process, the process comprising:
searching a keyword from text data; and
generating a signal for holding printing of the text data when the keyword has been found.

2. The computer readable medium according to claim 1, the process further comprising:
holding printing when the signal for holding printing is detected;
receiving input identification data; and
releasing the holdwhen the received identification data and registered identification data are matched.

3. The computer readable medium according to claim 2, the process further comprising:
transmitting print data including the text data, the signal for holding printing and the identification data to a printer or a print controller when the signal for holding printing is generated.

4. The computer readable medium according to claim 2, wherein the identification data is input to the printer.

5. The computer readable medium storing a printing program according to claim 2, wherein the identification data is input using a mobile communication device.

6. The computer readable medium storing a printing program according to claim 2, wherein the identification data is a password.

7. An electronic device, comprising:
a keyword searching section that searches a keyword from text data; and
a printing holding controller that controls so that printing of the text data is held when the keyword has been found.

8. The electronic device according to claim 7, further comprising a reception section that receives identification data, and wherein
the printing holding controller releases the hold when the received identification data and registered identification data are matched.

9. The electronic device according to claim 8, further comprising:
a transmission section that transmits print data including the text data, the signal for holding printing and the identification data to a printer or a print controller when the signal for holding printing is generated.

10. An electronic device control method, comprising:
searching a keyword from text data; and
controlling so that printing of the text data is held when the keyword has been found.

11. The electronic device control method according to claim 10, further comprising:
holding printing when the signal for holding printing is detected;
receiving input identification data; and
releasing the hold when the received identification data and registered identification data are matched.

12. The computer readable medium according to claim 11, the process further comprising:
transmitting print data including the text data, the signal for holding printing and the identification data to a printer or a print controller when the signal for holding printing is generated.

13. A computer data signal embodied in a carrier wave for enabling a computer to perform a process for controlling printing, the process comprising:
searching a keyword from text data; and
generating a signal for holding printing of the text data when the keyword has been found.

14. The electronic device control method according to claim 13, further comprising:
holding printing when the signal for holding printing is detected;
receiving input identification data; and
releasing the hold when the received identification data and registered identification data are matched.

15. The computer readable medium according to claim 14, the process further comprising:
transmitting print data including the text data, the signal for holding printing and the identification data to a printer or a print controller when the signal for holding printing is generated.
